(19) United States
(12) Patent Application Publication
(10) Pub. No.: US 2025/0037308 A1
(43) Pub. Date: Jan. 30, 2025

(54) INFORMATION PROCESSING SYSTEM, INFORMATION PROCESSING METHOD, AND PROGRAM

(71) Applicant: CANON KABUSHIKI KAISHA, Tokyo (JP)

(72) Inventors: KAZUFUMI ONUMA, Kanagawa (JP); TAKESHI FURUKAWA, Kanagawa (JP)

(21) Appl. No.: 18/783,041

(22) Filed: Jul. 24, 2024

(30) Foreign Application Priority Data
Jul. 25, 2023 (JP) 2023-120684

(51) Int. Cl. G06T 7/73; G06T 15/20

(52) U.S. Cl. CPC G06T 7/75; G06T 15/205; G06T 2200/24; G06T 2207/20101; G06T 2207/30221

(57) ABSTRACT

An information processing system includes one or more memories storing instructions, and one or more processors executing the instructions to: acquire subject information indicating a position of a subject, images of which are captured by a plurality of imaging apparatuses, in a virtual space that corresponds to a position in a real space, region information indicating a region in the virtual space, and interest position information indicating an interest position associated with the region, and in a case where the subject exists within the region, determine a position of a virtual viewpoint corresponding to a virtual viewpoint image and a line-of-sight direction from the virtual viewpoint based on the subject information and the interest position information.

### BACKGROUND OF THE DISCLOSURE

### Field of the Disclosure

The present disclosure relates to an information processing system that sets a virtual viewpoint corresponding to a virtual viewpoint image.

### Description of the Related Art

A technique of performing synchronous image capturing by installing a plurality of cameras at different positions, and generating an image (virtual viewpoint image) from an arbitrary virtual camera (virtual viewpoint) that is based on a user operation, using a plurality of images obtained by image capturing has attracted attention. By such a technique, it becomes possible to view a highlight scene of soccer or basketball, for example, from various angles, and it is possible to cause the user to feel a higher sense of realism as compared with normal images.

To easily operate virtual viewpoints, Japanese Patent Application Laid-Open No. 2022-171436 discusses a method of determining the position and the orientation of a virtual viewpoint based on position information of a first subject to be observed and position information of a second subject desired to fall within a virtual viewpoint image together with the first subject.

### SUMMARY OF THE DISCLOSURE

According to an aspect of the present disclosure, an information processing system includes one or more memories storing instructions, and one or more processors executing the instructions to: acquire subject information indicating a position of a subject, images of which are captured by a plurality of imaging apparatuses, in a virtual space that corresponds to a position in a real space, region information indicating a region in the virtual space, and interest position information indicating an interest position associated with the region, and in a case where the subject exists within the region, determine a position of a virtual viewpoint corresponding to a virtual viewpoint image and a line-of-sight direction from the virtual viewpoint based on the subject information and the interest position information.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of an image processing system according to a first exemplary embodiment.

FIGS. 2A to 2E are diagrams illustrating subject position tracking processing according to one or more aspects of the present disclosure.

FIGS. 3A and 3B are diagrams illustrating processing of allocating an identifier to a subject position according to one or more aspects of the present disclosure.

FIG. 4 is a diagram illustrating an example of a representative position of a subject according to one or more aspects of the present disclosure.

FIG. 5 is a flowchart illustrating processing in which a tracking unit according to one or more aspects of the present disclosure which tracks the position of a subject.

FIG. 6 is a flowchart illustrating processing in which an interest target determination unit according to one or more aspects of the present disclosure which determines an interest target.

FIGS. 7A and 7B are diagrams illustrating an example of a speed vector of each subject and an average speed vector according to one or more aspects of the present disclosure.

FIG. 8 is a diagram illustrating an example of a position of a virtual viewpoint generated by a viewpoint generation unit according to one or more aspects of the present disclosure.

FIG. 9 is a flowchart illustrating processing in which an interest target determination unit according to one or more aspects of the present disclosure which determines an interest target.

FIG. 10 is a diagram illustrating an example of an interest target and a determination region according to one or more aspects of the present disclosure.

FIGS. 11A, 11B, and 11C are diagrams illustrating an example of motions of a subject, an interest target, and a virtual viewpoint according to one or more aspects of the present disclosure.

FIG. 12 is a block diagram illustrating a hardware configuration example of an information processing apparatus.

FIG. 13 is a flowchart illustrating an example of processing to be executed by a viewpoint generation unit according to one or more aspects of the present disclosure.

FIGS. 14A, 14B, and 14C are diagrams each illustrating an example of a viewpoint position determination region according to one or more aspects of the present disclosure.

FIGS. 15A and 15B are diagrams each illustrating an example of a viewing angle of a virtual viewpoint generated by the viewpoint generation unit according to one or more aspects of the present disclosure.

FIG. 16 is a diagram illustrating an example of a table indicating a combination of a viewpoint position determination region and an interest target according to one or more aspects of the present disclosure.

FIGS. 17A and 17B are diagrams each illustrating an example of a virtual viewpoint generated by a viewpoint generation unit according to one or more aspects of the present disclosure.

### DESCRIPTION OF THE EMBODIMENTS

### (System Configuration and Operation of Image Processing Apparatus)

A first exemplary embodiment will be described. An image processing system is a system that generates a virtual viewpoint image representing a view from a designated virtual viewpoint, based on a plurality of images based on image capturing executed by a plurality of imaging apparatuses, and the designated virtual viewpoint. Although the virtual viewpoint image according to the present exemplary embodiment is also called a free viewpoint video, the virtual viewpoint image is not limited to an image corresponding to a viewpoint freely (arbitrarily) designated by a user, and the virtual viewpoint image also includes an image corresponding to a viewpoint selected by the user from among a plurality of candidates, for example. In the present exemplary embodiment, the description will be mainly given of a case where the virtual viewpoint image is a moving image, but the virtual viewpoint image may be a still image.

Viewpoint information to be used for the generation of the virtual viewpoint image is information indicating the position and orientation (line-of-sight direction) of a virtual viewpoint. Specifically, the viewpoint information is a parameter set including a parameter indicating a three-dimensional position of a virtual viewpoint, and parameters indicating orientations of the virtual viewpoint in pan, tilt, and roll directions. Parameters included in the viewpoint information are not limited to the above-described parameters. For example, a parameter set serving as the viewpoint information may include a parameter indicating the size (viewing angle) of a viewing field of a virtual viewpoint. In addition, the viewpoint information may include a plurality of parameter sets. For example, the viewpoint information may be information including a plurality of parameter sets respectively corresponding to a plurality of frames included in a moving image, which is a virtual viewpoint image, and indicating positions and orientations of virtual viewpoints at a plurality of consecutive time points.

The image processing system includes a plurality of imaging apparatuses that capture images of an image capturing region from a plurality of directions. The image capturing region is, for example, a playing field where soccer or karate is performed, or a stage for concert or theatrical performance. The plurality of imaging apparatuses is installed at different positions in such a manner as to surround such an image capturing region and synchronously perform image capturing. The plurality of imaging apparatuses need not be installed over the whole circumference of the image capturing region. Depending on restrictions on installation locations, the plurality of imaging apparatuses may be installed only in a part of the circumference of the image capturing region. The number of imaging apparatuses is not limited to those in the examples illustrated in the drawings. For example, in a case where the image capturing region is a soccer field, about 30 imaging apparatuses may be installed on the circumference of the image capturing region. In addition, imaging apparatuses having different functions such as a telecamera and a wide-angle camera may be installed.

The plurality of imaging apparatuses according to the present exemplary embodiment are assumed to be cameras each having an independent housing and capable of capturing an image at a single viewpoint. Nevertheless, the imaging apparatuses are not limited to such imaging apparatuses, and two or more imaging apparatuses may be formed within the same housing. For example, a single camera that includes a plurality of lens units and a plurality of sensors and can capture images from a plurality of viewpoint may be installed as a plurality of imaging apparatuses.

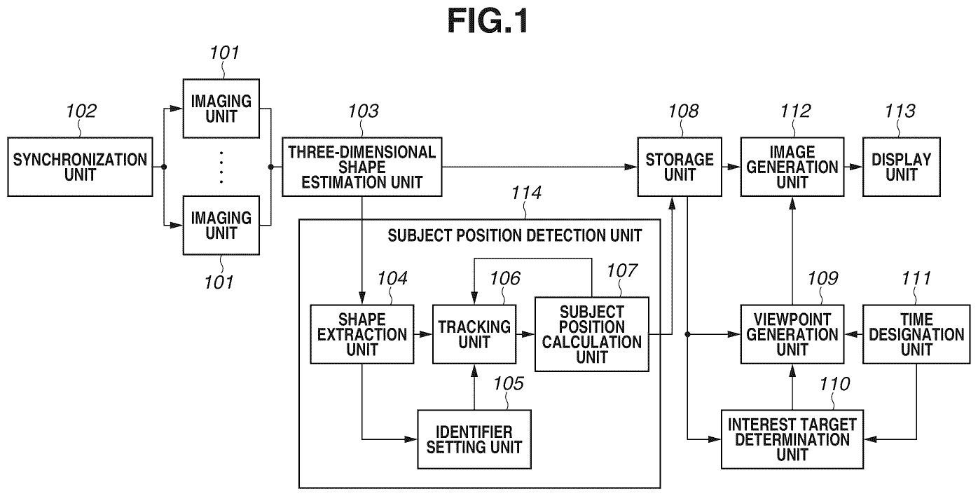

FIG. 1 is a block diagram illustrating a configuration of an image processing system according to the first exemplary embodiment. The image processing system includes, for example, imaging units 101, a synchronization unit 102, a three-dimensional shape estimation unit 103, a shape extraction unit 104, an identifier setting unit 105, a tracking unit 106, a subject position calculation unit 107, a storage unit 108, a viewpoint generation unit 109, an interest target determination unit 110, and a time designation unit 111. The image processing system further includes an image generation unit 112 and a display unit 113. In the present exemplary embodiment, the shape extraction unit 104, the identifier setting unit 105, the tracking unit 106, and the subject position calculation unit 107 will be collectively referred to as a subject position detection unit 114. The image processing system may include only one image processing apparatus, or may be a system including a plurality of image processing apparatuses.

For example, the viewpoint generation unit 109, the interest target determination unit 110, the time designation unit 111, and the subject position detection unit 114 may be included in one information processing apparatus different from an image processing apparatus, or the storage unit 108 may be included in a dedicated server apparatus. The following description will be given assuming that the image processing system is one image processing apparatus.

The imaging units 101 perform image capturing while synchronizing with each other based on a synchronization signal output by the synchronization unit 102.

Then, the imaging units 101 output captured image to the three-dimensional shape estimation unit 103. To capture images of the subject from a plurality of directions, the imaging units 101 are installed in such a manner as to surround an image capturing region including a subject.

The synchronization unit 102 outputs a synchronization signal to the plurality of the imaging units 101.

The three-dimensional shape estimation unit 103 generates a silhouette image of the subject using the input captured images from a plurality of viewpoints. Furthermore, the three-dimensional shape estimation unit 103 generates a three-dimensional (3D) model of the subject using the shape-from-silhouette or the like. The three-dimensional shape estimation unit 103 also outputs the generated 3D model of the subject and the captured images to the storage unit 108 and the shape extraction unit 104. The subject refers to an object a 3D model of which is to be generated, and includes a person and goods to be handled by a person.

The shape extraction unit 104 extracts a part of the 3D model of the subject that has been acquired from the three-dimensional shape estimation unit 103. By extracting a part of the 3D model of the subject, in a case where 3D models of a plurality of subjects exist, it is possible to reduce the possibility that each subject becomes unidentifiable due to the contact or adjacency between subjects. The shape extraction unit 104 further generates a two-dimensional image obtained by projecting the extracted 3D model of the subject from one direction. In the present exemplary embodiment, the shape extraction unit 104 generates a two-dimensional image by projecting the extracted 3D model of the subject from a direction vertical to a floor surface. Then, the shape extraction unit 104 extracts extraction information of the 3D model of the subject from the generated two-dimensional image, and transmits the extraction information to the tracking unit 106 and the identifier setting unit 105.

The identifier setting unit 105 allocates an identifier to the extraction information acquired from the shape extraction unit 104. The identifier setting unit 105 transmits an identifier allocated to each extracted shape to the tracking unit 106.

In response to the input of an identifier from the identifier setting unit 105, the tracking unit 106 allocates the identifier to each extracted shape as an initial state. After that, the tracking unit 106 performs the tracking of an extracted shape to which the identifier is allocated. The tracking unit 106 transmits the tracked extracted shape and the identifier to the subject position calculation unit 107.

The subject position calculation unit 107 calculates a representative position of each subject (subject position) using the extracted shape and the identifier that have been acquired from the tracking unit 106. The calculated representative position of the subject is transmitted to the storage unit 108.

The storage unit 108 saves and stores the following data constellation as data (virtual viewpoint material data) to be used for the generation of a virtual viewpoint image. Specifically, the data to be used for the generation of a virtual viewpoint image in the present exemplary embodiment includes the 3D model and captured images of the subject that have been input from the three-dimensional shape estimation unit 103. The data to be used for the generation of a virtual viewpoint image also includes camera parameters such as the position and orientation, and optical characteristics of each imaging unit, and subject information acquired by the subject position detection unit 114. As data to be used for the generation of a background of a virtual viewpoint image, a 3D model of a background and a background texture image are preliminarily saved (stored) in the storage unit 108. Furthermore, each 3D model to be stored in the storage unit 108 is stored in association with a corresponding type. The type is set for each image capturing target. For example, in the case of basketball, the type is player, ball, or referee. The type of each 3D model may be designated by the user, or may be automatically set in accordance with a preset condition. The storage unit 108 also stores an interest target candidate to be described below. The interest target candidate may be a background model, or may be a specific three-dimensional coordinate (interest position) in a three-dimensional space (virtual space). The following description will be given assuming that an interest target candidate is preset by the user, but may be automatically set by an apparatus. An interest target candidate to be automatically set by an apparatus may be, for example, a center position of an image capturing region including a plurality of image capturing locations or a subject existing at the center position, or the position of a boundary region between the image capturing region and another region, or a subject existing at the position. In the present exemplary embodiment, the description will be given assuming that the interest target candidate is a background model. The background model is a stationary object such as a goal of basketball, a goal of soccer, or a goal line of athletic sports, for example. The background model also includes a site such as a basketball court and a soccer field.

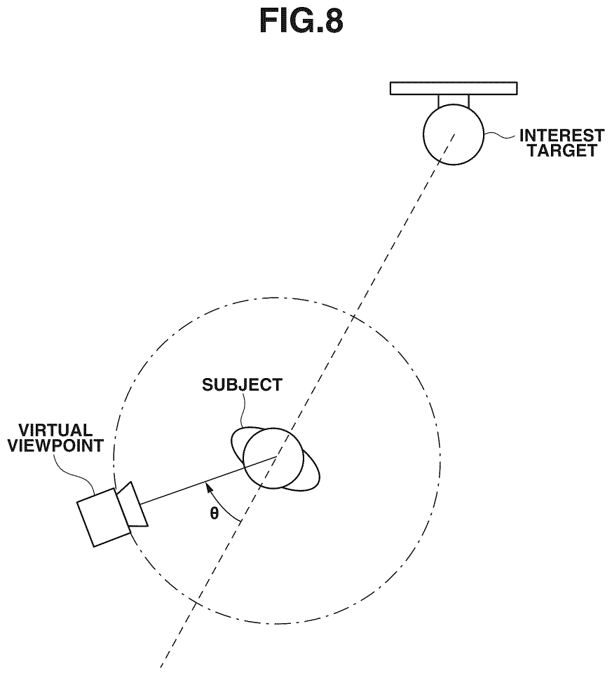

The viewpoint generation unit 109 generates a virtual viewpoint based on the subject information detected by the subject position detection unit 114 and position information of an interest target output by the interest target determination unit 110. Specifically, as illustrated in FIG. 8, the viewpoint generation unit 109 sets the position of the virtual viewpoint at a position distant from a subject designated by the user, by a predetermined distance in a direction rotated around the position of the subject by a predetermined rotational angle θ from a straight line connecting the subject and a centroid position of the background model, which is an interest target. Then, the viewpoint generation unit 109 sets a line-of-sight direction from the virtual viewpoint and a viewing angle in such a manner that the subject and the background model are included in a viewing field of this virtual viewpoint (virtual camera). Then, the viewpoint generation unit 109 generates virtual viewpoint information indicating parameters such as the position of the virtual viewpoint, the line-of-sight direction from the virtual viewpoint, and the viewing angle of the virtual viewpoint, and outputs the virtual viewpoint information to the image generation unit 112. The position of the virtual camera may be set on the straight line connecting the position of the subject designated by the user and the centroid position of the background model, which is an interest target. The rotational angle θ may be set by the user. The viewpoint generation unit 109 includes a viewpoint operation unit, which is a physical user interface (not illustrated), such as a joystick or an operation button, and a display unit for displaying a virtual viewpoint image. Using the viewpoint operation unit, parameters for generating virtual viewpoint information such as a distance between a subject included in a virtual viewpoint image and a virtual viewpoint, the orientation from the virtual viewpoint, and the height of the virtual viewpoint can be set. In accordance with the change of the parameters, a virtual viewpoint image is updated as necessary by the image generation unit 112 to be described below, and the updated virtual viewpoint image is displayed on the display unit. As the display unit, the display unit 113 to be described below may be used, or another display device may be included. The virtual viewpoint information to be output by the viewpoint generation unit 109 includes information corresponding to camera external parameters such as the position and orientation of a virtual viewpoint, information corresponding to camera internal parameters such as a focal length and a viewing angle, and time information designating an image capturing time at which an image to be reproduced is captured.

The interest target determination unit 110 determines one of a plurality of preset interest target candidates to be an interest target, based on interest target determination processing to be described below, and outputs the determined interest target to the viewpoint generation unit 109.

The time designation unit 111 generates time information for designating a time of a virtual viewpoint image desired to be generated by the image generation unit 112 to be described below, and outputs the time information to the viewpoint generation unit 109 and the interest target determination unit 110.

The time designation unit 111 includes at least either one user interface of a physical user interface (not illustrated) such as a plurality of buttons and a jog dial, or a graphical user interface (GUI), and can change a time at which a video is to be generated, by a user operation.

The image generation unit 112 acquires, based on time information included in the input virtual viewpoint information, material data of the image capturing time from the storage unit 108. The image generation unit 112 generates a virtual viewpoint image at a set virtual viewpoint using the 3D model of the subject and captured images in the acquired material data, and outputs the virtual viewpoint image to the display unit 113. The 3D model of the subject that has been generated by the three-dimensional shape estimation unit 103 is colored using the captured images. Specifically, from among a plurality of imaging apparatuses, an imaging apparatus that is positioned at a position close to the position of the set virtual viewpoint, and has a line-of-sight direction from the imaging apparatus close to a line-of-sight direction from the virtual viewpoint is identified. A plurality of imaging apparatuses may be identified, or one imaging apparatus may be identified. Next, a texture image is generated by blending a captured image captured by the identified imaging apparatus. At this time, a larger weight of blending may be applied to an imaging apparatus that is positioned at a position closer to the position of the virtual viewpoint, and has a line-of-sight direction closer to the line-of-sight direction from the virtual viewpoint. Through the above-described processing, it is possible to set colors in a captured image of a real space as colors of a 3D model of a subject, and generate a 3D model closer to a real subject.

The display unit 113 is a display unit that displays a video input from the image generation unit 112. The display unit 113 includes a display or a head-mounted display (HMD).

### (Tracking Method of Subject Position)

Next, a tracking method of a three-dimensional position of a subject according to the present exemplary embodiment will be described.

First, the three-dimensional shape estimation unit 103 generates a 3D model of a subject and outputs the generated 3D model to the storage unit 108, and also outputs the generated 3D model to the shape extraction unit 104.

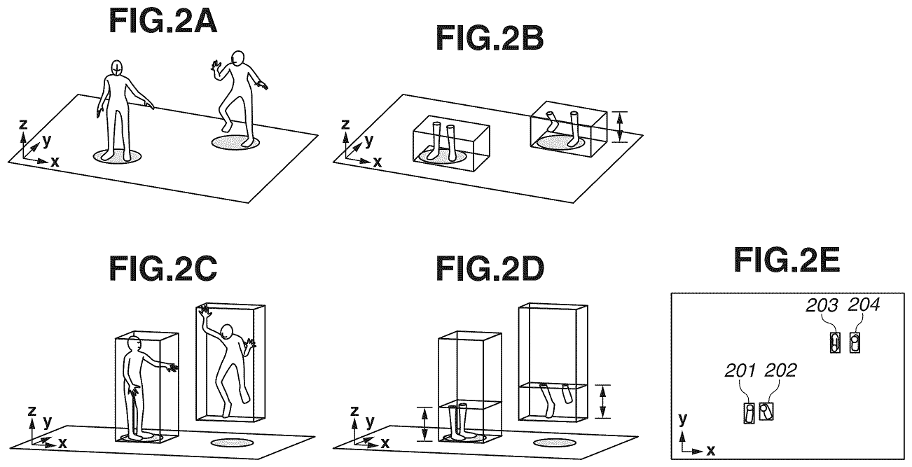

FIGS. 2A to 2E are diagrams illustrating subject position tracking processing according to the first exemplary embodiment. The shape extraction unit 104 extracts lower portions of 3D models of subjects as illustrated in FIG. 2B, from 3D models of subjects as illustrated in FIG. 2A. In the present exemplary embodiment, the shape extraction unit 104 extracts a portion of a circumscribed cuboid of a 3D model of each subject that starts from a bottom surface up to a predetermined height (e.g., height corresponding to 50 cm). For example, in a case where one subject is standing and another subject has no contact with the floor surface of an image capturing region due to jumping as illustrated in FIG. 2C, the ranges illustrated in FIG. 2D are extracted from the 3D models of the subjects. More specifically, portions of the 3D models of both the subjects that start from portions of feet up to the predetermined height are extracted. A region to be extracted from a 3D model is not limited to a lower portion. For example, a middle portion of a 3D model of a subject (e.g., a region from 50 cm to 100 cm from the bottom surface of a circumscribed cuboid of a 3D model) may be extracted.

Next, as illustrated in FIG. 2E, the shape extraction unit 104 generates a two-dimensional image by projecting the extracted 3D models on the floor surface. In the present exemplary embodiment, the projected image is a binary image in which portions of the extracted 3D models are colored in white and other portions are colored in black. The shape extraction unit 104 divides this two-dimensional image into independent regions, and obtains circumscribed rectangles 201 to 204 of these regions as illustrated in FIG. 2E. The shape extraction unit 104 outputs vertex information of the circumscribed rectangles as an extracted shape of an extracted 3D model. Specifically, the shape extraction unit 104 converts the vertex information of the circumscribed rectangles into the same coordinate system and the same unit as those of a three-dimensional space of an image capturing region, and outputs the vertex information. For example, a method such as continuous component analysis is used by the shape extraction unit 104 to determine independent shapes in a projected two-dimensional image. By using such a method, the shape extraction unit 104 can divide a 3D model into individual regions.

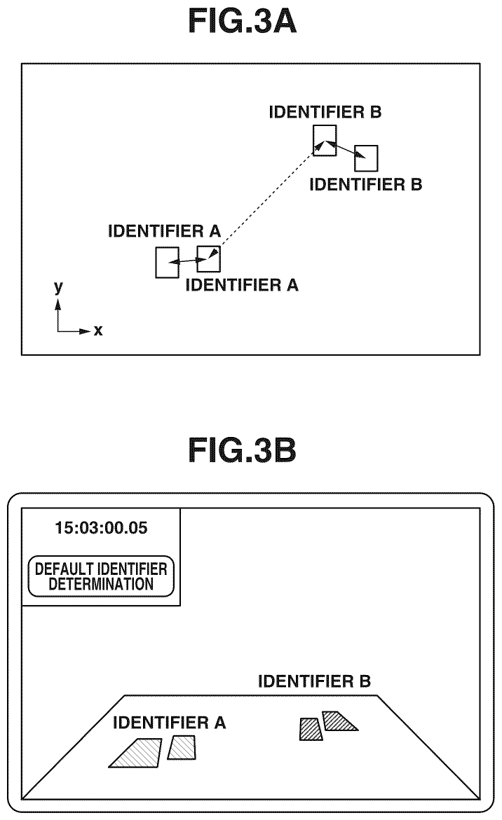

FIGS. 3A and 3B are diagrams illustrating processing of allocating an identifier to a subject position according to the first exemplary embodiment. The identifier setting unit 105 allocates an identifier to an extracted shape output by the shape extraction unit 104. Specifically, the identifier setting unit 105 calculates a distance between extracted shapes, and allocates an identifier in accordance with the distance between the extracted shapes. For example, as illustrated in FIG. 3A, the identifier setting unit 105 allocates the same identifier to extracted shapes the distance between which is smaller than a predetermined distance (solid arrow), and allocates different identifiers to extracted shapes the distance between which is equal to or larger than the predetermined distance (dashed arrow). A threshold value of the predetermined distance to be used as a criterion for determining is desirably set to a distance corresponding to a foot breadth of a standing subject. In the present exemplary embodiment, the description will be given assuming that the threshold value of the predetermined distance is set to 50 cm.

The identifier setting unit 105 displays the allocated identifiers on a display unit included in the identifier setting unit 105, using a GUI as illustrated in FIG. 3B. The user operates the image processing system while viewing this GUI. Specifically, the identifier setting unit 105 displays the current identifier allocation (identifier allocation in an initial state) on the GUI while making discrimination using at least either of characters and color coding. In FIG. 3B, the identifier setting unit 105 displays identifiers using both of characters and color coding. The user checks the GUI and confirms whether desired identifiers are allocated as an initial state. In a case where desired identifiers are not allocated, the user issues an instruction to subjects to change their standing positions or close their legs, and this is repeated until desired allocation is obtained. Alternatively, the user operates the image processing system via the GUI, and issues a change instruction in such a manner that desired identifiers are allocated. In a case where desired identifiers are allocated, the user presses a determination button (default identifier determination button) on the GUI as illustrated in FIG. 3B, for example. In accordance with this operation, the identifier setting unit 105 determines an identifier in an initial state. Furthermore, the identifier setting unit 105 may set the type of each subject for the identifier in the initial state. This type is assumed to be set for each image capturing target (for example, baseball, live performance, etc.). In the present exemplary embodiment, basketball is assumed, and one type from among player, referee, or ball is set for each subject. This type is assumed to be set in accordance with user input, but the type setting method is not limited to this. For example, a condition of setting ball as the type of a subject corresponding to an extracted shape around which another extracted shape does not exist within a predetermined distance in the initial state may be preset, and the type may be set simultaneously with the determination of an identifier. Then, the identifier setting unit 105 outputs information indicating the identifier and the type determined for each extracted shape, to the tracking unit 106.

In response to the input of an identifier from the identifier setting unit 105, the tracking unit 106 allocates the identifier to each extracted shape as an initial state. Then, the tracking unit 106 performs the tracking of an extracted shape to which the identifier is allocated. As an identifier to be allocated to an extracted shape during the tracking, not an identifier determined by the identifier setting unit 105 but an identifier determined based on a tracking result of the position of each extracted shape that is obtained by the tracking unit 106 is used. In the tracking of extracted shapes, the tracking unit 106 tracks extracted shapes based on the position of each extracted shape at a time immediately before an image capturing time of a corresponding extracted shape, an identifier of each extracted shape, and information regarding a subject position that is input from the subject position calculation unit 107 to be described below. Specific processing of tracking to be executed by the tracking unit 106 will be described below.

The tracking unit 106 allocates an identifier to each extracted shape at the time based on the tracking result, and outputs each extracted shape to the subject position calculation unit 107.

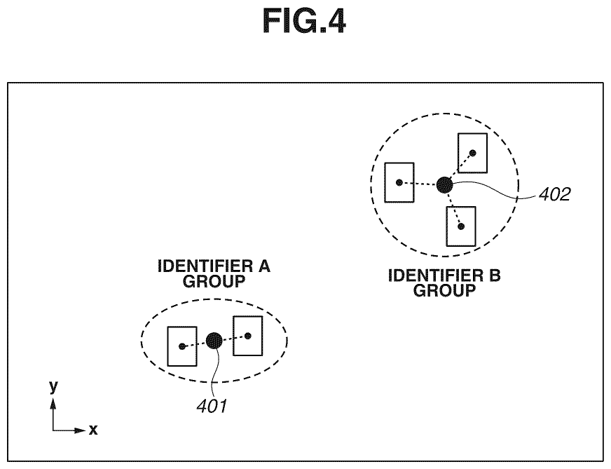

FIG. 4 is a diagram illustrating a representative position of a subject according to the first exemplary embodiment. The subject position calculation unit 107 obtains a representative position of the extracted shapes assigned the identifiers that have been acquired by the tracking unit 106. For example, as illustrated in FIG. 4, the subject position calculation unit 107 obtains a position indicating an extracted shape group, for each extracted shape group assigned the same identifier, like representative positions 401 and 402. In the present exemplary embodiment, a representative position is assumed to be set to a center position of each extracted shape group.

Nevertheless, because this representative position is affected by a shape estimation error or a fluctuation of a boundary portion that is caused when the shape extraction unit 104 extracts a shape, even when a subject is stationary, the representative position fluctuates at each time in some cases. For this reason, in the present exemplary embodiment, the subject position calculation unit 107 performs processing such as low-pass filter processing or moving average processing on center position information at each time in a time direction, and generates position information in which high-frequency components are reduced. Then, the subject position calculation unit 107 outputs, as the position of a subject, position information of the representative position to the tracking unit 106 together with the identifier. In addition, the subject position calculation unit 107 records (stores), into the storage unit 108, information in which information regarding a time at which the image of the subject is captured is allocated to the position information of the representative position, as position information of the subject (subject information).

As described in the above-described processing, by generating a 3D model of a subject from a captured image of a real space, and obtaining a representative position of the 3D model, it is possible to identify a position of the subject in a virtual space that corresponds to a position of the subject in the real space.

### (Tracking Processing to Be Executed by Tracking Unit 106)

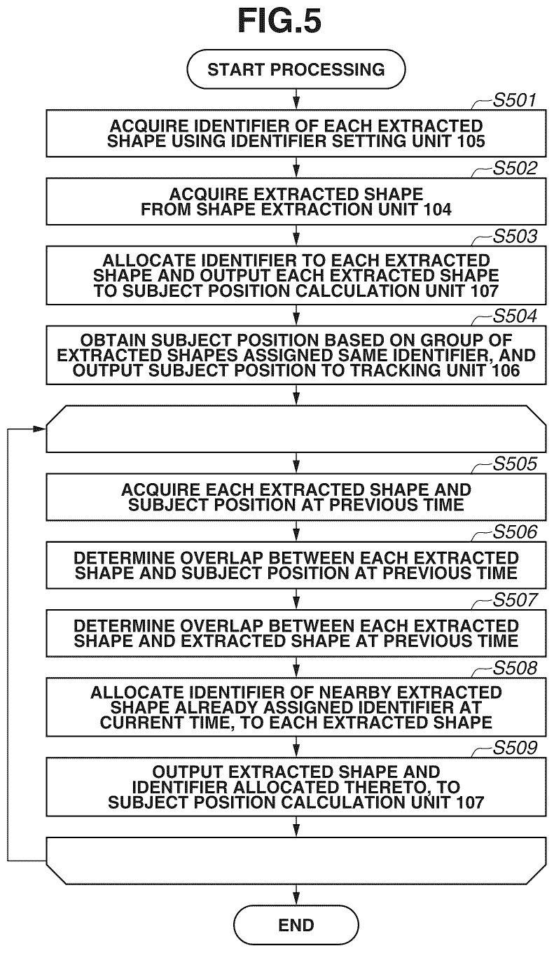

FIG. 5 is a flowchart illustrating processing in which the tracking unit 106 according to the first exemplary embodiment tracks the position of a subject.

In step S501, the tracking unit 106 acquires identifiers and types of extracted shapes upon receiving input from the identifier setting unit 105.

In step S502, the tracking unit 106 subsequently acquires extracted shapes input from the shape extraction unit 104.

In step S503, the tracking unit 106 allocates the identifiers and the types that have been acquired from the identifier setting unit 105, to the acquired extracted shapes, and outputs the extracted shapes assigned the identifiers and types, to the subject position calculation unit 107.

In step S504, the subject position calculation unit 107 obtains a subject position from an extracted shape group assigned the same identifier, and outputs the subject position to the tracking unit 106.

The above-described processing in steps S501 to S504 corresponds to initialization processing.

The following processing in steps S505 to S509 is processing to be executed at each time, and is repeatedly executed while the imaging units 101 are capturing images of the subject. In a case where image capturing processing of the subject that is executed by the imaging units 101 has ended, the processing of this flowchart ends upon the completion of the processing in step S509.

In step S505, the tracking unit 106 acquires the extracted shapes input from the shape extraction unit 104 and a subject position at a time (previous time) immediately before an image capturing time that has been calculated by the subject position calculation unit 107. The time immediately before an image capturing time is, for example, an image capturing time of an extracted shape generated in a frame immediately before a frame of a currently-processed extracted shape. For comparison, the current time will also be described as the present time. The current time refers to an image capturing time of an image used to generate the currently-processed extracted shape.

In step S506, in a case where a subject position at the previous time and a representative position of extracted shapes at the present time overlap, the tracking unit 106 allocates an identifier allocated to the subject position overlapping the representative position, to the extracted shapes. In step S506, in a case where a representative position of one extracted shape overlaps a plurality of subject positions, the tracking unit 106 allocates an identifier indicating “indeterminable” to the extracted shape at the present time. This is because there is a possibility that a plurality of extracted shapes assigned different identifiers overlap at the present time like a state in which two subjects are proximate to each other, for example. In the processing in this step, an identifier indicating “indeterminable” is accordingly allocated. The processing in step S509 to be described below is executed on an extracted shape assigned an identifier including an identifier indicating “indeterminable”.

In step S507, in a case where a representative position of an extracted shape not assigned an identifier yet overlaps an extracted shape at the previous time, the tracking unit 106 allocates an identifier allocated to the extracted shape at the previous time, to the extracted shape at the present time.

In step S508, in a case where a different extracted shape already assigned an identifier at the present time exists within a predetermined range from an extracted shape not assigned an identifier yet, the tracking unit 106 allocates the identifier allocated to the different extracted shape. The predetermined range is desirably set to a range corresponding to a foot breadth of a standing subject. For example, the predetermined range is a range within a 50-cm radius from the center of the extracted shape. In a case where a plurality of different extracted shapes assigned identifiers exists within the predetermined range from a certain extracted shape, the tracking unit 106 allocates an identifier of a closest extracted shape among the different extracted shapes, to the extracted shape. The tracking unit 106 determines an extracted shape to which an identifier has not been allocated at the stage where the processing up to step S508 ends, to be an extracted shape not to be tracked. In this case, the tracking unit 106 does not output, to the subject position calculation unit 107, the extracted shape determined to be an extracted shape not to be tracked.

In step S509, the tracking unit 106 outputs, to the subject position calculation unit 107, an extracted shape to which an identifier is allocated in the processing in steps S506 to S508, and the identifier allocated thereto.

The processing in steps S506 to S508 is performed for each extracted shape. By repeating the processing in steps S506 to S509, an identifier set by the identifier setting unit 105 is associated with an extracted shape at each time.

Using this identifier, the subject position calculation unit 107 can obtain a subject position of each subject while making discrimination between subjects.

In a case where the tracking unit 106 allocates an identifier indicating “indeterminable”, to an extracted shape as an identifier, at a certain time, some identifiers of identifiers defined by a default setting might fail to be allocated. In such a case where, the subject position calculation unit 107 does not update subject information including the same identifier as an identifier not allocated to an extracted shape. With this configuration, even in a case where extracted shapes overlap by a plurality of subjects getting closer to each other, a plurality of pieces of subject information do not correspond to the same position. In this case, as a plurality of subject positions, positions set until the previous time are maintained. After that, in a case where a plurality of overlapping extracted shapes get separated again by subjects getting separated from each other, an identifier is allocated to each extracted shapes based on the latest subject position. In other words, upon the overlap between the plurality of extracted shapes being released, the update of subject information is restarted.

Through the above-described processing, even in a case where a plurality of subjects exists within an image capturing region, the image processing system can track an individual subject and acquire position information of an individual subject. Furthermore, through the above-described processing, even in a case where overlap or separation between generated 3D models occurs due to subjects getting closer to each other or getting separated from each other, the image processing system can track an individual subject.

### (Interest Target Determination Processing)

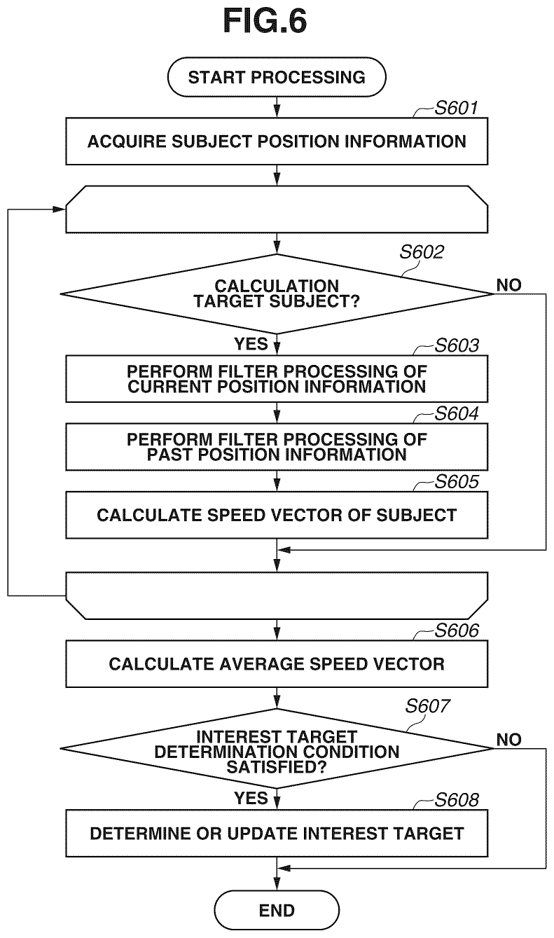

FIG. 6 is a flowchart illustrating processing in which the interest target determination unit 110 according to the first exemplary embodiment determines an interest target. In the present exemplary embodiment, the description will be given of an example of determining an interest target when a virtual viewpoint image of basketball is to be generated. In this case, interest target candidates include basketball goals of both teams, and position information of the interest target candidates is preliminarily acquired from the storage unit 108. The processing is executed for each frame.

Based on a user operation, a specific background model is additionally determined to be an interest target candidate from among a plurality of background models.

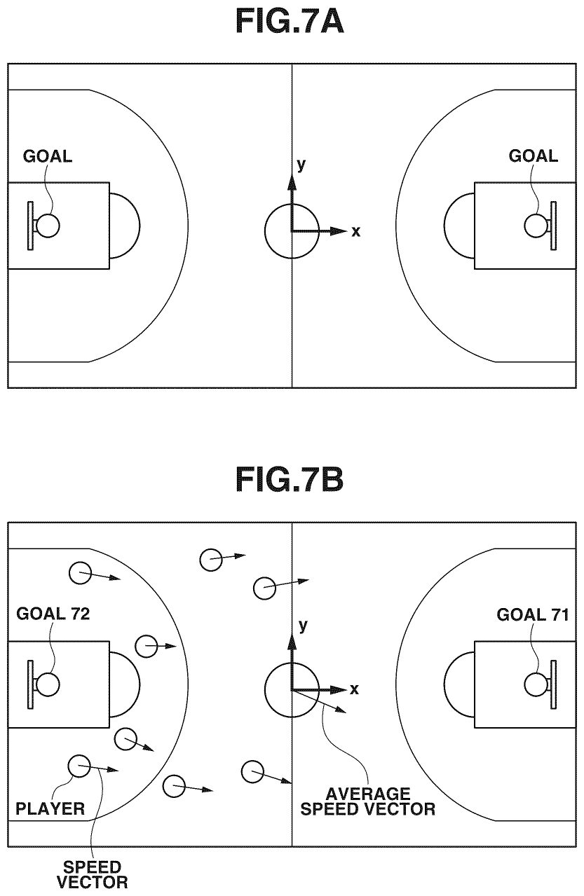

FIGS. 7A and 7B are diagrams illustrating a speed vector of each subject and an average speed vector according to the present exemplary embodiment. Coordinate axes x and y are defined as illustrated in FIG. 7A, a court center is set as an origin (0, 0), and basketball goals exist on an x-axis.

In step S601, the interest target determination unit 110 acquires subject information based on a time designated by the time designation unit 111, from subject information detected by the subject position detection unit 114 and recorded in the storage unit 108. At this time, the interest target determination unit 110 acquires not only subject information of the designated time but also subject information of several frames to several tens of frames before and after the time. In steps S602 to S605 to be described below, the processing is performed for each subject.

In step S602, it is determined whether a certain subject is a calculation target subject. Specifically, it is determined whether to perform the subsequent processing, based on whether a type corresponding to an identifier for identifying a subject that is included in position information is consistent with calculation target information. The calculation target information is information designating a calculation target of interest target determination processing, and is information designating a type corresponding to an identifier of a subject. For example, a calculation target information indicating that a subject a type of which corresponding to an identifier is player is set as a calculation target is generated and preliminarily recorded in the storage unit 108 or the interest target determination unit 110. In this case, by excluding a subject the type of which is either referee or ball, from a calculation target, it is possible to exclude the subject from the target of the interest target determination processing.

In step S603, filter processing of position information of the subject determined to be a calculation target is performed. Specifically, the position information is calculated by averaging pieces of position information corresponding to a plurality of frames that have been acquired in step S601. This can reduce a fluctuation attributed to a detection error of the subject position detection unit 114.

In step S604, subject information of a past time earlier than the time of the calculation target subject such as a time one second before the time and several frames to several tens of frames (predetermined time) before and after the time, for example, is acquired, and an average value thereof is calculated.

In step S605, by subtracting the averaged position information of the past time from the averaging-processed position information of the time, and then dividing the obtained difference in position information by a time difference between the time and the past time (one second in this example), a position deviation (position change) per unit time of the time is obtained. The magnitude of the position deviation per unit time corresponds to a moving speed, and the orientation of a vector on a two-dimensional plane is a moving direction of the subject. The above-described processing in steps S602 to S605 is performed for each subject. In a case where the processing has been completed for all subjects, the processing proceeds to step S606.

In step S606, an average speed vector of the obtained speed vectors of all calculation target subjects is calculated. FIG. 7B illustrates the calculated average speed vector of all the calculation target subjects. In the present exemplary embodiment, a component of a goal direction that is included in the average speed vector is obtained. Specifically, because the goal direction is a positive or negative direction of the x-axis, the orientation and the magnitude of a vector obtained by orthographically-projecting the average speed vector to a vector of (1, 0) is obtained.

In step S607, it is determined whether the average speed vector calculated in step S606 satisfies an interest target determination condition. The interest target determination condition is assumed to vary for each image capturing target.

In the present exemplary embodiment, it is determined whether a vector obtained by projecting the average speed vector in the goal direction satisfies the interest target determination condition. In the case of an initial state in which an interest target is not determined, the processing proceeds to step S608 irrespective of whether the interest target determination condition is satisfied. In the present exemplary embodiment, the interest target determination condition includes whether the orientation of the vector obtained by projecting the average speed vector in the goal direction is oriented toward the current interest target, and whether the magnitude of the vector is larger than a predetermined magnitude. In a case where the current interest target is determined, an interest target change is determined based on the orientation and the magnitude of the orthographically-projected vector. In a case where the orthographically-projected vector is oriented in a positive direction, the magnitude of the orthographically-projected vector is equal to or larger than the predetermined magnitude, and the current interest target is not an x-axis positive side goal 71, the processing proceeds to step S608.

In a case where the vector is oriented in a negative direction, the magnitude of the vector is equal to or larger than the predetermined magnitude, and a currently-observed goal is not an x-axis negative side goal 72, the processing proceeds to step S608. In a case where neither of the conditions is satisfied, the processing of determining an interest target in the current frame ends without changing the current interest target.

In step S608, from among a plurality of interest target candidates, one interest target is determined based on the average speed vector. In the case of the initial state in which an interest target is not determined, a straight line is extended in the direction of the average speed vector, and an interest target closest to the straight line is identified. In a case where a plurality of interest targets closest to the straight line exist, an interest target closest to the position of a subject to be observed is identified. Alternatively, a default value of an interest target may be preset by a user operation. In the present exemplary embodiment, an interest target change is determined based on the orientation and the magnitude of the orthographically-projected vector.

In a case where the orthographically-projected vector is oriented in the positive direction, the magnitude of the orthographically-projected vector is equal to or larger than the predetermined magnitude, and the current interest target is not the x-axis positive side goal 71, the goal 71 is determined to be (identified as) an interest target. In a case where the vector is oriented in the negative direction, the magnitude of the vector is equal to or larger than the predetermined magnitude, and a currently-observed goal is not the x-axis negative side goal 72, the goal 72 is determined to be an interest target.

By performing such processing in steps S601 to S608 for each frame, motions of all subjects are detected and an interest target is determined. The interest target determination unit 110 outputs information regarding the determined interest target to the viewpoint generation unit 109.

As described above, the viewpoint generation unit 109 arranges a virtual viewpoint in a direction rotated by the predetermined angle from the straight line connecting the subject and the interest target. When the interest target switches from the goal 71 to the goal 72, instead of immediately switching a viewpoint, the viewpoint generation unit 109 obtains a current angle and an angle to be set after switching, and then interpolates a virtual viewpoint by rotating the virtual viewpoint by the angle difference over a predetermined time. This enables a viewer to correctly recognize that a currently-observed interest target has been switched, at the time of switching of the interest target.

In this manner, according to the present disclosure, in sports such as basketball, it is possible to detect offense and defense switching based on motions of all subjects, and the viewpoint generation unit 109 can accordingly automatically generate a virtual viewpoint in such a manner as to catch an offense side goal. It accordingly becomes possible to generate a virtual viewpoint image suitable for a scene while tracking a subject designated by the user, in such a manner as to include the subject in the virtual viewpoint image.

In the present exemplary embodiment, a goal direction component of the average speed vector is calculated in step S606, but a direction component to be calculated varies depending on an image capturing target and an interest target candidate. For example, in a case where 100-metre dash of athletic sports is set as an image capturing target, a straight line from a start to a goal is set along an x-axis direction. In this manner, a direction component of the average speed vector that is to be calculated varies depending on an image capturing target and an interest target. For this reason, for example, in a case where a combination of a plurality of interest target candidates is determined, a predetermined component direction may be preliminarily provided and stored for the combination.

In the present exemplary embodiment, the goal direction component of the average speed vector is calculated in step S606, but the processing in step S606 is not limited to this. An interest target may be identified based on the orientation of the average speed vector. Specifically, a straight line is provided along the direction of the average speed vector, and an interest target closest to the straight line is identified. A plurality of interest target candidates closest to the straight line might exist. In this case, an interest target closest to the position of a subject to be observed is further identified. Accordingly, it is possible to identify one interest target from among a plurality of interest target candidates.

### (Other Configurations of First Exemplary Embodiment)

In the present exemplary embodiment, a subject position detection unit that is based on a shape estimation result has been described as the subject position detection unit 114, but the present disclosure is not limited to the method of detecting the position of the subject. For example, a configuration of attaching a position sensor such as the global positioning system (GPS) to a player and then acquiring a sensor value of the position sensor may be employed. Aside from this, a configuration of detecting a subject position using an image recognition technique from images obtained by a plurality of image capturing means may be employed.

In the present exemplary embodiment, a configuration in which the interest target determination unit 110 calculates a speed and a moving direction for each frame at the time of virtual viewpoint image generation has been described, but the configuration is not always limited to this. For example, a configuration in which the subject position detection unit 114 detects a position, calculates a speed vector of each subject, and records the speed vector in the storage unit 108 may be employed. In this case, the interest target determination unit 110 may acquire the speed vector of each subject from the storage unit 108, and determine an interest target.

In the present exemplary embodiment, averaging processing is performed as filter processing of position information, but the filter processing of position information is not limited to this. For example, a low-pass filter such as an infinite impulse response (IIR) filter or a finite impulse response (FIR) filter may be used. Nevertheless, in the case of the configuration of calculating a speed and the like for each frame, if a low-pass filter is used, in a case where a reproduction time of a virtual viewpoint image is discontinuously changed, a value becomes improper. Thus, in the case of such a configuration, it is desirable to execute averaging after information regarding a near time is acquired as described above.

In the present exemplary embodiment, basketball is used as an example, but the present disclosure may be applied to sports such as soccer or rugby. For example, in the case of soccer, match progress is slower as compared with basketball, and a time during which all players are stopped sometimes gets relatively longer. In such a case, a side of a field on which subjects (players) stay for a longer time may be determined, and an interest target may be determined by comprehensively determining the determination result and speed vectors of subjects.

In the first exemplary embodiment, an interest target is determined from an average speed vector of all subjects, which is players. Nevertheless, an interest target may be determined based on the motion of one player. For example, in the case of generating a virtual viewpoint image in such a manner as to track a runner of baseball, an interest target may be determined by focusing attention on the motion of the runner. In a second exemplary embodiment, an example in which baseball is set as an image capturing target will be described. In the present exemplary embodiment, a block diagram is similar to FIG. 1, and because the components not to be specifically described are similar to those in the first exemplary embodiment, the description will be omitted.

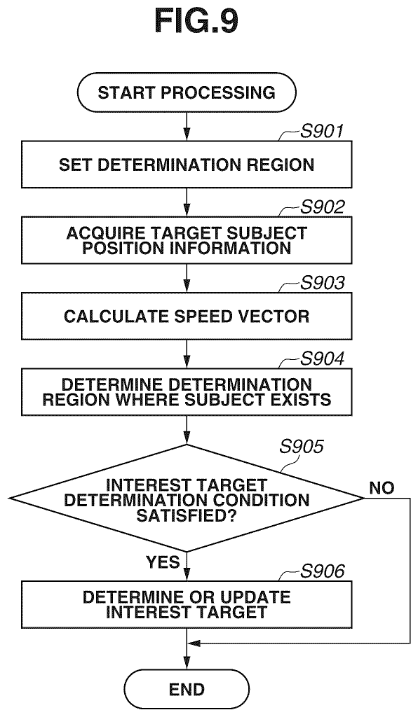

FIG. 9 is a flowchart illustrating processing in which an interest target determination unit 110 according to the second exemplary embodiment determines an interest target. The processing is executed for each frame.

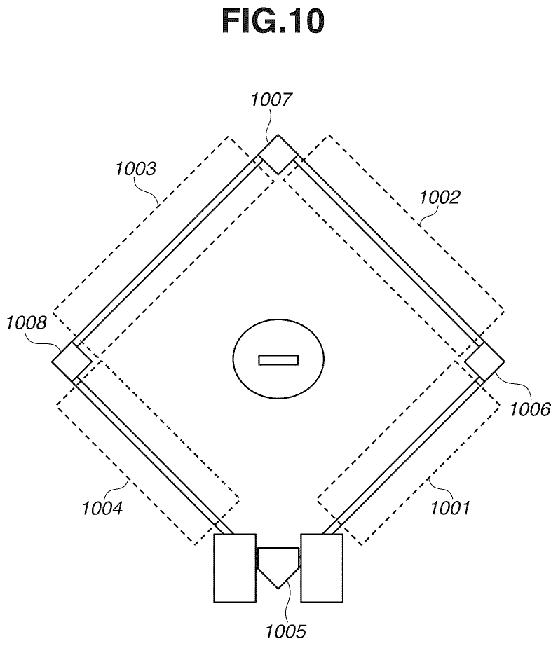

FIG. 10 is a diagram illustrating an example of interest target candidates and an interest target determination region (predetermined region) according to the second exemplary embodiment. In the present exemplary embodiment, bases of baseball including a home base 1005, a first base 1006, a second base 1007, and a third base 1008 are set as interest target candidates.

In step S901, the interest target determination unit 110 sets a first interest target determination region 1001, a second interest target determination region 1002, a third interest target determination region 1003, and a fourth interest target determination region 1004 in accordance with a user operation. At this time, an interest target candidate to be associated with each interest target determination region is set. Specifically, the home base 1005 and the first base 1006 are associated with the first interest target determination region 1001. Similarly, the first base 1006 and the second base 1007 are associated with the second interest target determination region 1002, the second base 1007 and the third base 1008 are associated with the third interest target determination region 1003, and the third base 1008 and the home base 1005 are associated with the fourth interest target determination region 1004. In addition, the interest target determination unit 110 acquires position information of interest target candidates associated with an interest target determination region, and obtains a direction vector connecting two interest target candidates. For example, in the case of the second interest target determination region 1002, a unit direction vector connecting the first base 1006 and the second base 1007 is obtained. At this time, the unit direction vector is a vector indicating a second base direction. The interest target determination region and the position information of the interest target candidates may be managed as condition information, and may be stored in the interest target determination unit 110 or may be stored in the storage unit 108. The processing in step S901 is executed only for an initial frame in which an interest target is determined, instead of being executed for each frame. The processing timing is not limited to this, and the processing in step S901 may be executed at an arbitrary timing designated by the user.

In step S902, the interest target determination unit 110 acquires, from subject information detected by the subject position detection unit 114 and recorded in the storage unit 108, subject information that is based on a time designated by the time designation unit 111.

In step S903, similarly to the first exemplary embodiment, a speed vector of the subject is obtained. At this time, similarly to the first exemplary embodiment, filter processing is performed on the acquired position information of the subject.

In step S904, the interest target determination unit 110 determines an interest target determination region where the subject exists, from among the four preset interest target determination regions. In the present exemplary embodiment, the description will be given assuming that the subject exists within the second interest target determination region 1002. Next, a plurality of interest target candidates associated with the second interest target determination region 1002 is identified. In the present exemplary embodiment, the first base 1006 and the second base 1007 are set as interest target candidates.

In step S905, it is determined whether the speed vector calculated in step S903 satisfies an interest target determination condition. Similarly to the first exemplary embodiment, in the case of the initial state in which an interest target is not determined, the processing proceeds to step S906 irrespective of whether an interest target determination condition is satisfied. The interest target determination unit 110 obtains the orientation and the magnitude of a vector obtained by orthographically-projecting the speed vector of the subject to a unit direction vector associated with the interest target determination region. In the present exemplary embodiment, the interest target determination condition includes whether the magnitude of the orthographically-projected vector is larger than the predetermined magnitude. In a case where the magnitude of the orthographically-projected vector is larger than the predetermined magnitude (YES in step S905), the processing proceeds to step S906. In a case where the magnitude of the orthographically-projected vector is equal to or smaller than the predetermined magnitude (NO in step S905), the processing ends.

In step S906, one interest target is determined based on the average speed vector from among the plurality of interest target candidates identified in step S904. The processing to be performed in the case of the initial state in which an interest target is not determined is similar to that in the first exemplary embodiment. In a case where the magnitude of the orthographically-projected vector is larger than the predetermined magnitude and the orientation of the orthographically-projected vector is the same second base direction as the above-described unit direction vector, the second base 1007 is determined to be an interest target. In a case where the orientation of the orthographically-projected vector is an orientation opposite to the unit direction vector, the first base 1006 is determined to be an interest target. By performing the processing in steps S902 to S906 for each frame, it is possible to generate a virtual viewpoint that focuses attention on an appropriate interest target, while tracking the motion of a player.

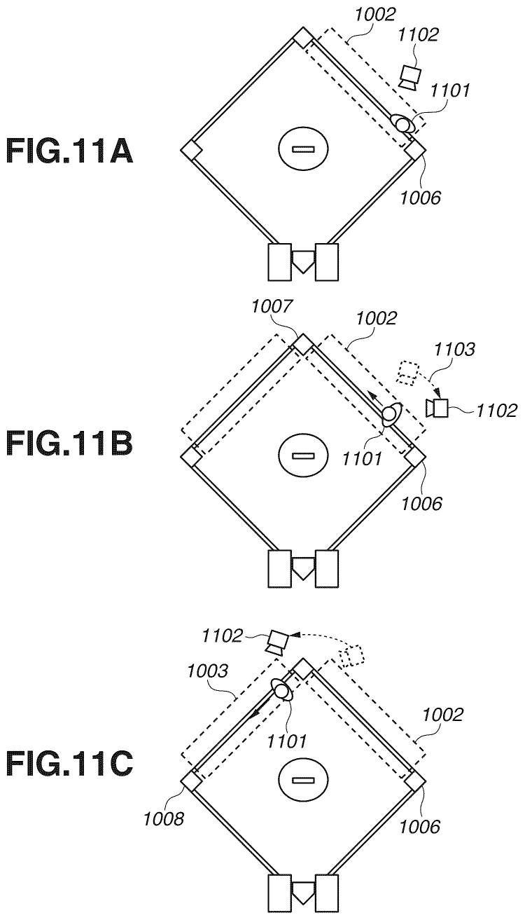

FIGS. 11A to 11C are diagrams illustrating motions of a subject, an interest target, and a virtual viewpoint according to the second exemplary embodiment. Specifically, the motion of a player (runner) and the switching of an interest target will be described with reference to FIGS. 11A to 11C. A state in which a runner 1101 exists near the first base 1006 as illustrated in FIG. 11A will be described. When the runner 1101 exists near the first base 1006, because the runner 1101 has passed through the first interest target determination region 1001 before reaching the point, a currently-observed interest target is the first base 1006. At this time, although the runner 1101 leads and enters the second interest target determination region 1002, since the runner 1101 moves at low speed, an interest target remains unchanged from the first base 1006. A virtual viewpoint to be generated by the viewpoint generation unit 109 at this time is a virtual viewpoint 1102 viewing the runner 1101 and the first base 1006 from obliquely behind the runner 1101 as illustrated in FIG. 11A. Next, if the runner 1101 starts to run in such a manner as to move up a base, and the speed becomes equal to or larger than a predetermined speed, an interest target to be observed switches to the second base 1007. The virtual viewpoint 1102 tracking the runner 1101 accordingly rotates around the runner 1101 as indicated by a dashed arrow 1103 in FIG. 11B, and automatically transitions to the virtual viewpoint 1102 viewing the second base 1007 over the shoulder of the runner 1101 while tracking the runner 1101. For example, in a case where the runner 1101 tries to return to the first base 1006 during moving-up of a base, an interest target to be observed switches to the first base 1006, and the virtual viewpoint 1102 transitions to the virtual viewpoint 1102 including the runner 1101 and the first base 1006. Next, in a case where the runner 1101 succeeds in moving up a base and tries to further move up to the third base 1008, the runner 1101 enters the third interest target determination region 1003. The moving direction and the speed are accordingly determined based on a unit direction vector defined by the second base 1007 and the third base 1008 associated with the third interest target determination region 1003. Consequently, at the time point at which the runner 1101 enters the third interest target determination region 1003, an interest target to be observed becomes the third base 1008, and as illustrated in FIG. 11C, the virtual viewpoint 1102 moves to a position including the runner 1101 and the third base 1008.

By applying the present disclosure in this manner, it becomes possible to identify an appropriate interest target from among a plurality of interest target candidates based on the position of a player and speed information, and it becomes possible for the viewpoint generation unit 109 to generate an appropriate virtual viewpoint based on the identified interest target. With this configuration, it becomes possible to create an appropriate camera work adapted to a situation, even when an operator operating a virtual viewpoint does not exist.

### (Other Configurations of Second Exemplary Embodiment)

Similarly to the first exemplary embodiment, the subject position detection unit 114 may use another position detection method such as the GPS and image recognition.

In the present exemplary embodiment, the description has been given assuming that a virtual viewpoint to be generated by the viewpoint generation unit 109 is a virtual viewpoint of tracking a subject from behind, but the virtual viewpoint to be generated is not limited to this. The viewpoint generation unit 109 may be any viewpoint generation unit as long as the viewpoint generation unit generates a virtual viewpoint using information regarding a currently-observed subject and an interest target to be observed. For example, the viewpoint generation unit 109 may arrange a virtual viewpoint near a base set as an interest target, and create a camera work in such a manner that a tracking target subject falls within a viewing angle by waiting for the tracking target subject.

In this case, it is desirable that, in accordance with the switching of an interest target, the arrangement of a virtual viewpoint transitions to the vicinity of a base to be set as an interest target, while capturing a tracking target subject from the front side.

In the present exemplary embodiment, it is assumed that a virtual viewpoint is automatically generated by the viewpoint generation unit 109, and an operator is unnecessary, but the configuration is not always limited to this. For example, an operator may be enabled to operate, via a user interface (not illustrated), a distance between a player and a virtual viewpoint to be generated by the viewpoint generation unit 109, the height at which the virtual viewpoint is to be arranged, and a viewing angle. With this configuration, while the viewpoint generation unit 109 brings a subject and an interest target into a viewing angle, the operator can control a composition such as a viewing angle, which is more desirable.

In the present exemplary embodiment, the present disclosure is applied to baseball, but the present disclosure may be applied to a sporting event such as softball or another sport in which an interest target desired to be included in a virtual viewpoint image switches based on a position where a player exists.

In the present exemplary embodiment, an interest target candidate is set to a background model, and the position and the orientation of a virtual viewpoint are determined based on the position of a subject designated by the user and a centroid position of an interest target, but the configuration is not limited to this.

For example, a three-dimensional position different from a centroid position may be associated with a background model, which is an interest target candidate. In this case, the position and the orientation of a virtual viewpoint are determined based on the position of a subject designated by the user and a three-dimensional position corresponding to an interest target. Through such processing, it becomes possible to easily set a virtual viewpoint suitable for a scene in a case where a goal net such as a net of a basketball goal is positioned at a position different from a centroid position of a background model. The three-dimensional position corresponding to the background model may be set at the same height as a centroid position of a subject. For example, in a case where an interest target is a base of baseball, the interest target exists on a floor surface, and a virtual viewpoint image corresponding to a virtual viewpoint directed toward the floor surface might be generated. For this reason, by adjusting the height of a three-dimensional position corresponding to a background model, it is possible to easily set a virtual viewpoint suitable for a scene.

In the first and second exemplary embodiments, the position of the virtual viewpoint is set at a position distant from a subject designated by the user, by a predetermined distance in a direction rotated around the position of the subject by a predetermined rotational angle θ from a straight line connecting the subject and a centroid position of the background model, which is an interest target. In a third exemplary embodiment, by determining a rotational direction in accordance with the position of a subject, the position of a virtual viewpoint more suitable for a scene is set. In the present exemplary embodiment, processing of generating a virtual viewpoint video of basketball will be described as an example. An interest target is set to a basketball goal.

In the third exemplary embodiment, a rotational direction is determined in accordance with a viewpoint position determination region where a subject is positioned. The viewpoint position determination region is a region in which a direction in which a position is to be rotated around the subject with respect to a straight line connecting the subject and the interest target is set. The viewpoint position determination region is assumed to be generated in accordance with a user operation. In the present exemplary embodiment, an interest target region corresponding to a three-dimensional region in a three-dimensional space and a rotational direction are designated using a user device (not illustrated), and stored in the storage unit 108. In the present exemplary embodiment, the viewpoint position determination region is associated with the interest target, and a rotational direction is defined and stored for each interest target. A plurality of viewpoint position determination regions may be stored as one combination, or a plurality of interest targets may be associated with one viewpoint position determination region. In the present exemplary embodiment, a plurality of interest targets respectively corresponding to a plurality of viewpoint position regions are determined, and rotational directions corresponding to these combinations are stored as a table.

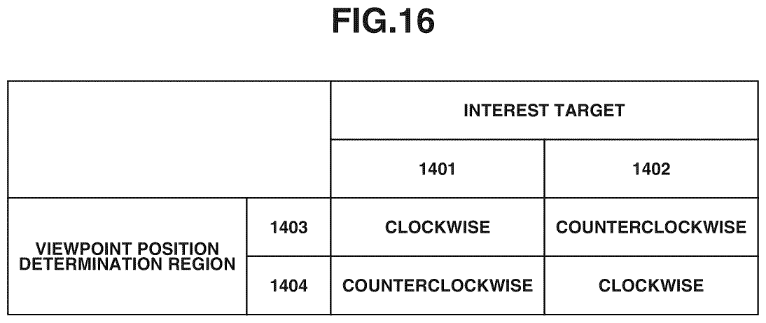

FIG. 16 is a diagram illustrating an example of a table indicating a combination of a viewpoint position determination region and an interest target according to the present exemplary embodiment. This table is created based on input from a user device (not illustrated), and stored in the storage unit 108. In the present exemplary embodiment, a virtual viewpoint video of basketball is assumed to be generated, and a table indicating combinations of two viewpoint position determination regions and two interest targets is stored. In the present exemplary embodiment, as for the combination of a viewpoint position determination region 1403 and an interest target 1401, a rotational direction is a clockwise direction. As for the combination of the viewpoint position determination region 1403 and an interest target 1402, a rotational direction is a counterclockwise direction. As for the combination of a viewpoint position determination region 1404 and the interest target 1401, a rotational direction is the counterclockwise direction. As for the combination of the viewpoint position determination region 1404 and the interest target 1402, a rotational direction is a clockwise direction.

### (Viewpoint Generation Processing)

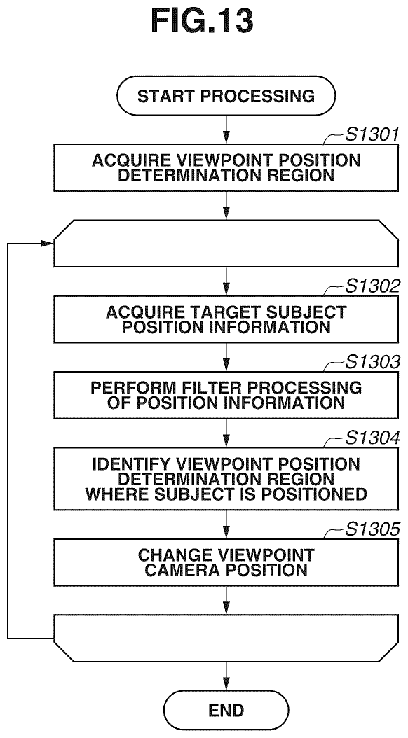

FIG. 13 is a flowchart illustrating an example of processing to be executed by the viewpoint generation unit 109 according to the present exemplary embodiment. The processing in this flowchart is executed after the completion of the processing of determining an interest target that is illustrated in FIG. 6. For this reason, the description of the processing of determining an interest target from among a plurality of interest target candidates will be omitted.

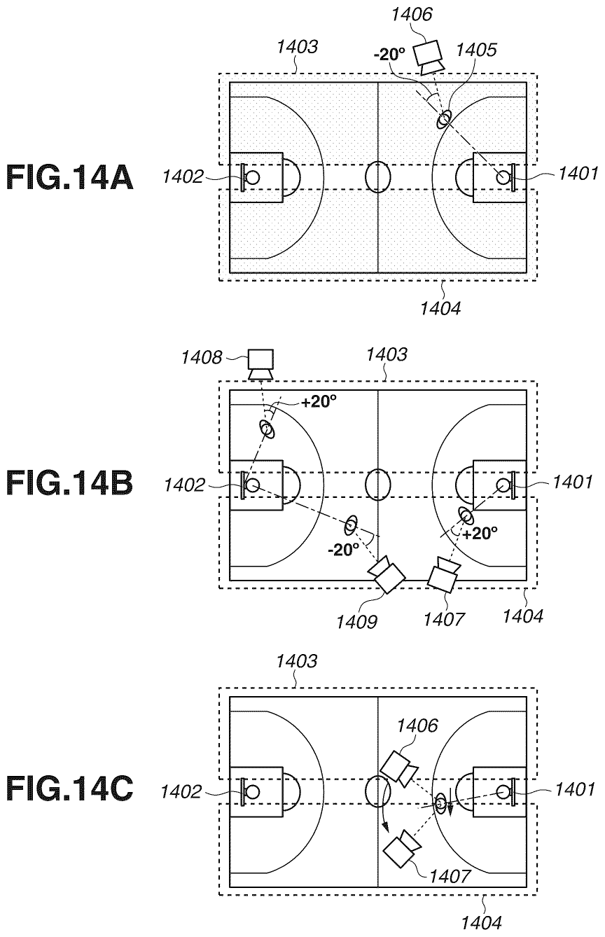

In step S1301, the viewpoint generation unit 109 acquires, from the storage unit 108, region information indicating a viewpoint position determination region. In the present exemplary embodiment, the viewpoint generation unit 109 acquires a table indicating combinations of viewpoint position determination regions and interest targets that is stored in the storage unit 108. Next, the viewpoint generation unit 109 acquires region information indicating a region in a three-dimensional space of a viewpoint position determination region that is recorded in the table and interest target information (interest position information) indicating the position of an interest target that is recorded in the table. Specifically, the viewpoint generation unit 109 acquires the viewpoint position determination region 1403 and the viewpoint position determination region 1404 illustrated in FIGS. 14A to 14C, from the storage unit 108.

In step S1302, the viewpoint generation unit 109 acquires position information of a subject designated by a user operation. The designated subject will be hereinafter referred to as a tracking target and will be described. Furthermore, the viewpoint generation unit 109 acquires not only subject information of the designated time but also subject information of several frames to several tens of frames before and after the time.

In step S1303, the viewpoint generation unit 109 performs filter processing of position information of the tracking target. Specifically, the position information is calculated by averaging pieces of position information corresponding to a plurality of frames that have been acquired in step S1302. This can reduce a fluctuation attributed to a detection error of the subject position detection unit 114.

In step S1304, the viewpoint generation unit 109 identifies a viewpoint position determination region where the tracking target is positioned. The description will be given using examples in FIGS. 14A to 14C. FIG. 14A illustrates the interest target 1401, the interest target 1402, the viewpoint position determination region 1403, the viewpoint position determination region 1404, a tracking target 1405, and a virtual viewpoint 1406. At this time, a viewpoint position determination region where the tracking target 1405 is positioned is identified as the viewpoint position determination region 1403. In other words, the tracking target 1405 is positioned within a region of the viewpoint position determination region 1403.

In step S1305, the viewpoint generation unit 109 generates virtual viewpoint information by arranging a camera at a location distant from the tracking target by a predetermined distance, and in a direction rotated by a predetermined angle θ from a straight line connecting the subject and the interest target. The direction in which rotation is performed at this time is determined based on the interest target and a viewpoint position determination region. In the case of the example illustrated in FIG. 14A, in a case where the interest target is a basketball goal 1401 and the tracking target 1405 exists in the viewpoint position determination region 1403, the virtual viewpoint 1406 is arranged at a position rotated by 20 degrees in a clockwise direction as a rotational direction. In the present exemplary embodiment, the description will be given assuming that the position is rotated by 20 degrees, but the rotational angle θ is not limited to this. The rotational angle θ is determined based on a user operation. The clockwise direction may be regarded as a minus direction and the counterclockwise direction may be regarded as a plus direction. Instead, the clockwise direction may be regarded as a plus direction and the counterclockwise direction may be regarded as a minus direction. In FIGS. 14A to 14C, the clockwise direction is illustrated as a minus direction and the counterclockwise direction is illustrated as a plus direction. As another example, in FIG. 14B, when an interest target remains unchanged from the basketball goal 1401 and the tracking target 1405 is positioned in the viewpoint position determination region 1404 on the opposite side, a virtual viewpoint 1407 is arranged by setting the predetermined angle θ to +20 degrees, which is a counterclockwise rotational angle. The rotational direction is changed in such a manner that a virtual viewpoint 1408 is arranged by setting the rotational angle θ to +20 degrees in a case where the interest target switches to the basketball goal 1402 and exists in the viewpoint position determination region 1403, and a virtual viewpoint 1409 is arranged by setting the rotational angle θ to −20 degrees in a case where the interest target exists in the viewpoint position determination region 1404.

When the interest target and the viewpoint position determination region switch, instead of discontinuously switching the predetermined angle θ, a viewpoint is smoothly switched over a time of about 0.3 to 1 seconds in such a manner as to interpolate between virtual viewpoints before and after the switching as illustrated in FIG. 14C. In the example in FIG. 14C, when the tracking target 1405 moves from the viewpoint position determination region 1403 to the viewpoint position determination region 1404, the virtual viewpoint transitions from the virtual viewpoint 1406 to the virtual viewpoint 1407 while interpolating positions of virtual viewpoints and line-of-sight directions from the virtual viewpoints. In a case where an interest target and a viewpoint position determination region do not switch, virtual viewpoint information changed in step S1305 is used as-is.

By performing the above-described processing in steps S1302 to S1305 for each frame, virtual viewpoint information that is based on positions of an interest target and a tracking target is generated, and the virtual viewpoint information is output to the image generation unit 112.

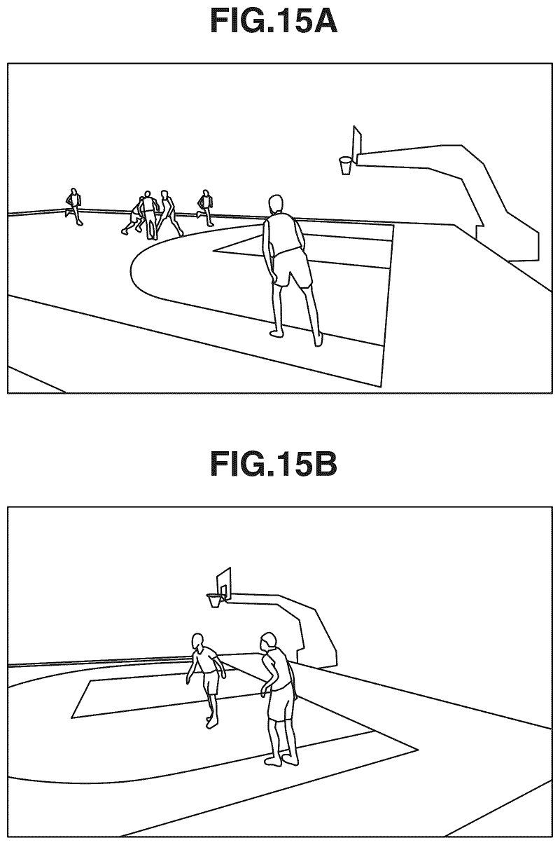

By performing the above-described processing, it is possible to automatically set the position of a virtual viewpoint that enables a viewer to look over a court while bringing a tracking target and an interest target into a viewing angle, and a line-of-sight direction from the virtual viewpoint, based on three items corresponding to a tracking target, an interest target, and a viewpoint position determination region. Specifically, in the case of determining the position of the virtual viewpoint and the line-of-sight direction from the virtual viewpoint based on two items corresponding to a tracking target and an interest position, a virtual viewpoint video illustrated in FIG. 15B is generated, and the play of other players is not displayed. As a result, there is a possibility that a scene cannot be easily recognized. In contrast to this, in the case of determining the position of the virtual viewpoint and the line-of-sight direction from the virtual viewpoint based on three items corresponding to a tracking target, an interest target, and a viewpoint position determination region, a virtual viewpoint image illustrated in FIG. 15A is generated, and because the play of other players is displayed more, a scene can be easily recognized.

In the present exemplary embodiment, a rotational direction is defined for a combination of a viewpoint position determination region and an interest target, but the configuration is not limited to this. For example, a rotational direction and a rotational angle may be defined. Alternatively, a positional relationship between an interest target and a subject in a virtual viewpoint image may be defined. Specifically, the positional relationship may be defined in such a manner that the position of the subject exists on the left side of the interest position in the virtual viewpoint image, or the position of the subject exists on the right side of the interest position. In other words, a positional relationship between the position of the interest target and the position of the subject based on an optical axis of the virtual viewpoint may be defined. The position of a virtual viewpoint and a line-of-sight direction from the virtual viewpoint are determined in such a manner as to be adapted to the defined positional relationship.

In the present exemplary embodiment, the viewpoint generation unit 109 automatically generates a virtual viewpoint. A configuration in which the user can set a parameter in generating a virtual viewpoint is desirable. For example, a viewpoint operation unit, which is a physical user interface (not illustrated), such as a joystick or an operation button, and a display unit for displaying a virtual viewpoint video may be included. In this configuration, a tracking target and an interest target may be dynamically changed using the viewpoint operation unit. A configuration in which a distance between a tracking target and a virtual viewpoint, a rotational angle, and the height of the virtual viewpoint can be set as the parameter is desirable. In accordance with the change of these parameters, a virtual viewpoint video is updated as necessary by the image generation unit 112, and displayed on a display unit. A display unit 113 is used as this display unit, or another display device may be included. As for the height of the virtual viewpoint, in a case where the body height of the tracking target is high, a virtual viewpoint position may be heightened based on the body height of the tracking target. At this time, the height of an object to be viewed by the virtual viewpoint may be changed together.

In the present exemplary embodiment, the switching of a tracking target has not been specifically mentioned, but a configuration of selecting a player from a list of players using a user interface or a configuration in which the selection is switched by clicking or tapping a player in a video is desirable. Aside from these configurations, a configuration of allocating each player to an operation button, and switching a player by pressing a button may be employed. When a player is switched, a camera may be switched by instantaneously moving a virtual viewpoint, but it is desirable to generate a viewpoint that interpolates between a viewpoint of tracking a player before switching, and a viewpoint of tracking a player after switching, for example. By generating a viewpoint in this manner, the viewpoint looks as if a virtual camera flied off between players, and it becomes easier for a viewer to recognize a resultant video as a continuous video. It also becomes easier to recognize that a tracking target has switched and recognize a positional relationship between before and after the switching. The interpolation to be performed at this time is desirably eased interpolation with acceleration and deceleration rather than linear interpolation.

In the present exemplary embodiment, viewpoint position determination regions are set as two regions, but the configuration is not limited to this. For example, a viewpoint position determination region may be a fan-shaped region that is based on an angle from a goal, which is an interest target. In this case, a rotational angle θ may be increased based on a region (angle).

In the present exemplary embodiment, the viewpoint position determination regions 1403 and 1404 are separated. For example, in a case where viewpoint position determination regions are adjacent to each other, if a tracking target moves into and out of a region boundary portion, a virtual viewpoint accordingly repeats viewpoint switching, and an undesirable video swinging from side to side is consequently obtained. In view of this, by providing a region where determination is not to be performed between viewpoint position determination regions, the change in angle of a virtual viewpoint is not performed in this region, and a rotational angle θ set so far is maintained. This provides substantial hysteresis, and as a result, continuous switching of virtual viewpoint is prevented. On the other hand, a configuration of preventing continuous switching by causing delay even when viewpoint position determination regions are adjacent to each other may be employed.

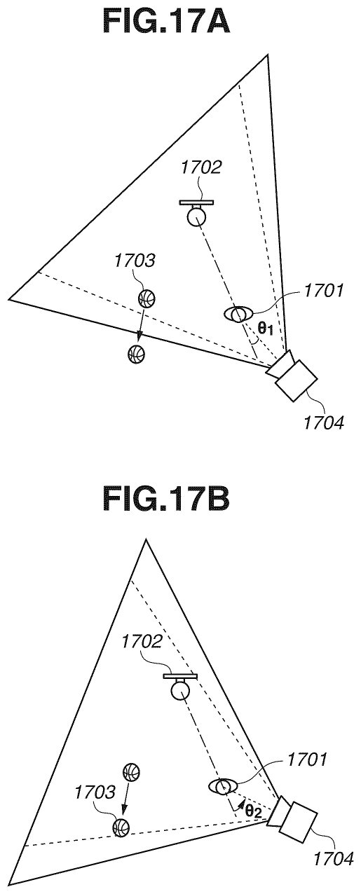

In the first to third exemplary embodiments, the description has been given assuming that the number of interest targets is one, but the number of interest targets is not always limited to this. The viewpoint generation unit 109 may generate a viewpoint using two or more interest targets. In a fourth exemplary embodiment, an example in which two items corresponding to a basketball goal 1702 and a basketball 1703 in basketball are regarded as interest targets will be described with reference to FIGS. 17A and 17B. First, different weights are preset to the basketball goal 1702 and the basketball 1703. Specifically, the basketball goal 1702 is regarded as a main interest target and the basketball 1703 is regarded as a sub interest target. As a difference between the main and sub interest targets, the main interest target (basketball goal 1702) is used as a criterion for determining the position of a virtual viewpoint 1704 together with a tracking target 1701 as described in the first exemplary embodiment. At this time, in a case where the sub interest target (basketball 1703) exists within a viewing angle defined by the tracking target 1701 and the main interest target (basketball goal 1702), a preset predetermined rotational angle (01) is maintained. Next, if the sub interest target (basketball 1703) reaches a position of about 10 to 20 percentage from a viewing angle end (dashed lines in FIGS. 17A and 17B), the viewpoint generation unit 109 changes a virtual viewpoint 1704 in such a manner that the sub interest target falls within a viewing angle of a virtual viewpoint. Specifically, by executing at least one of moving an angle of a virtual viewpoint in the direction of the sub interest target, keeping a virtual viewpoint position away from a tracking target, and shortening a focal length of a virtual viewpoint and making the virtual viewpoint wide-angle, the viewpoint generation unit 109 changes a virtual viewpoint in such a manner that both the main and sub interest targets fall within the viewing angle. In FIG. 17A, the basketball 1703 in a viewing angle moves and is about to go out of the viewing angle. At this time, by rotating the virtual viewpoint 1704 around the tracking target 1701 by a rotational angle θ2 in such a manner as to bring the basketball 1703 into a viewing angle of the virtual viewpoint 1704 as illustrated in FIG. 17B, the viewpoint generation unit 109 brings both the main and sub interest targets into the viewing angle.

Nevertheless, as for a positional relationship between the tracking target 1701 and the main and sub interest targets, there is a possibility that the main and sub interest targets are located at an abnormally-wide angle or separated too much. In this case, by imposing a restriction on a distance by which an interest target gets away from the tracking target 1701, or a viewing angle, and in a case where the sub interest target moves out of the viewing angle within the restriction, it is desirable to avoid tracking any more.

In the present exemplary embodiment, basketball is used as an example, but the present disclosure may be applied to sports such as soccer or rugby. Aside from this, a configuration of applying the present disclosure to baseball or softball and setting a viewpoint position determination region between bases may be employed. Moreover, the present disclosure may be applied to a sporting event in which an interest target desired to be included in a virtual viewpoint image switches based on a position where a player exists.

### (Other Configurations)

In the above-described exemplary embodiments, the description has been given assuming that the processing units illustrated in FIG. 1 each is configured by hardware. Nevertheless, processing to be performed by these processing units illustrated in FIG. 1 may be implemented by a computer program.

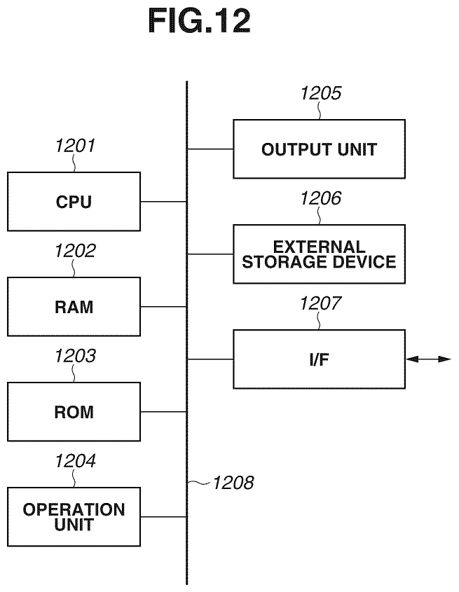

FIG. 12 is a block diagram illustrating a configuration example of hardware of a computer applicable to an indirect position estimation apparatus according to each of the above-described exemplary embodiments.

A central processing unit (CPU) 1201 controls the entire computer using computer programs and data stored in a random access memory (RAM) 1202 and a read-only memory (ROM) 1203, and also executes the processing described above as processing to be performed by an indirect position estimation apparatus according to each of the above-described exemplary embodiments. That is, the CPU 1201 functions as each of the processing units illustrated in FIG. 1.

The RAM 1202 includes an area for temporarily storing computer programs and data loaded from an external storage device 1206 and data acquired from the outside via an interface (I/F) 1207. The RAM 1202 further includes a work area to be used when the CPU 1201 executes various types of processing. That is, the RAM 1202 can be allocated as a frame memory, or appropriately provide other various areas, for example.

The ROM 1203 stores setting data of this computer and a boot program. An operation unit 1204 includes a keyboard and a mouse. By a user of this computer operating the operation unit 1204, it is possible to input various instructions to the CPU 1201. An output unit 1205 displays a processing result obtained by the CPU 1201. The output unit 1205 includes a liquid crystal display, for example. For example, the viewpoint generation unit 109 is implemented by the operation unit 1204 and the display unit 113 is implemented by the output unit 1205.

The external storage device 1206 is a large-capacity storage device represented by a hard disk drive device. The external storage device 1206 stores an operating system (OS), and a computer program for causing the CPU 1201 to implement the function of each unit illustrated in FIG. 1. Furthermore, the external storage device 1206 may store image data to be processed.

Computer programs and data stored in the external storage device 1206 are appropriately loaded onto the RAM 1202 in accordance with the control executed by the CPU 1201, and processed by the CPU 1201. A network such as a local area network (LAN) or the internet, and another device such as a projection device and a display device can be connected to the I/F 1207, and this computer can acquire and transmit various types of information via the I/F 1207. In the first exemplary embodiment, the imaging units 101 are connected to the I/F 1207, and captured images are input and controlled. A bus 1208 connects the above-described components.

Regarding the operation to be performed by the above-described components, the CPU 1201 mainly controls the operation described in the above-described exemplary embodiments.

Computer programs implementing a part or all of the control in the present exemplary embodiment and the functions of the above-described exemplary embodiments may be supplied to an image processing system via a network or various storage media. Then, a computer (or a CPU or a micro processing unit (MPU), etc.) in the image processing system reads out and executes the computer programs. In this case, the computer programs and storage media storing the computer programs are included in the present disclosure.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-120684, filed Jul. 25, 2023, which is hereby incorporated by reference herein in its entirety.

What is claimed is:

1. An information processing system comprising:
one or more memories storing instructions; and
one or more processors executing the instructions to:
acquire subject information indicating a position of a subject, images of which are captured by a plurality of imaging apparatuses, in a virtual space that corresponds to a position in a real space, region information indicating a region in the virtual space, and interest position information indicating an interest position associated with the region; and
in a case where the subject exists within the region, determine a position of a virtual viewpoint corresponding to a virtual viewpoint image and a line-of-sight direction from the virtual viewpoint based on the subject information and the interest position information.

2. The information processing system according to claim 1, wherein a position of the virtual viewpoint and a line-of-sight direction from the virtual viewpoint are determined based on a straight line passing through a position of the subject in the virtual space and the interest position.

3. The information processing system according to claim 2,
wherein the region and the interest position are associated with a predetermined rotational direction, and
wherein, in a case where the subject exists within the region, a position rotated in the predetermined rotational direction around a position of the subject in the virtual space with respect to the straight line is determined to be the position of the virtual viewpoint.

4. The information processing system according to claim 3, wherein a position rotated in the predetermined rotational direction by a predetermined angle around a position of the subject in the virtual space with respect to the straight line is determined to be the position of the virtual viewpoint.

5. The information processing system according to claim 4, wherein the predetermined angle is determined based on a user operation.

6. The information processing system according to claim 1, wherein the interest position is set based on setting a user operation.

7. The information processing system according to claim 1, wherein the interest position is associated with a background model.

8. The information processing system according to claim 7, wherein the background model is a stationary object.

9. The information processing system according to claim 8, wherein the background model is a basketball goal.

10. The information processing system according to claim 1, wherein a position of the virtual viewpoint and a line-of-sight direction from the virtual viewpoint are determined in such a manner that the virtual viewpoint image includes the subject and the interest position.

11. An information processing method comprising:
acquiring subject information indicating a position of a subject, images of which are captured by a plurality of imaging apparatuses, in a virtual space that corresponds to a position in a real space, region information indicating a region in a three-dimensional space, and interest position information indicating an interest position associated with the region; and
in a case where the subject exists within the region, determining a position of a virtual viewpoint corresponding to a virtual viewpoint image and a line-of-sight direction from the virtual viewpoint based on the subject information and the interest position information.

12. A non-transitory computer readable storage medium storing a program for causing a computer to execute an information processing method comprising:
acquiring subject information indicating a position of a subject, images of which are captured by a plurality of imaging apparatuses, in a virtual space that corresponds to a position in a real space, region information indicating a region in the virtual space, and interest position information indicating an interest position associated with the region; and
in a case where the subject exists within the region, determine a position of a virtual viewpoint corresponding to a virtual viewpoint image and a line-of-sight direction from the virtual viewpoint based on the subject information and the interest position information.
